(19) United States
(12) Patent Application Publication
(10) Pub. No.: US 2021/0113034 A1
(43) Pub. Date: Apr. 22, 2021

(54) AUTOMATIC FOOT WASHING AND DRYING DEVICE

(71) Applicant: Maxwell Levine, West Bloomfield, MI (US)

(72) Inventor: Maxwell Levine, West Bloomfield, MI (US)

(21) Appl. No.: 16/793,132

(22) Filed: Feb. 18, 2020

Related U.S. Application Data
(60) Provisional application No. 62/923,582, filed on Oct. 20, 2019.

(51) Int. Cl. A47K 10/48; A01K 13/00; A47K 7/04

(52) U.S. Cl. CPC A47K 10/48; A47K 7/04; A01K 13/001

(57) ABSTRACT

The present invention is a device that can rinse and dry an individual's feet or an animal's lower extremities. The devices rinses feet in a first stage and dries in a second stage. The first half of the apparatus has multiple mist spouts that send water from all different angles. The second part has air vents that send air on both sides for drying. The device cleans sand off of feet following the beach, pesticides or dirt off of boots before entering or leaving agriculture, or many other uses. The device is placed over any drain and connected to any power and water supply.

### CROSS-REFERENCE TO RELATED APPLICATION

This Application is a completion Application of Co-pending U.S. Provisional Patent Application Ser. No. 62/923,582, filed on Oct. 20, 2019 for “Automatic Foot Washing and Drying Device, the disclosure of which is hereby incorporated by reference, including the drawings.

### BACKGROUND OF THE INVENTION

### 1. Field of the Invention

The present invention pertains to cleaning appliances. More particularly, the present invention pertains to foot washing and drying appliances. Even more particularly, the present invention pertains to foot washing and drying devices for both humans and animals.

### 2. Prior Art

Sandy feet cause an immense amount of problems, including displacement of sand, discomfort, clogging of pool drains and cleaning fees in various environments, including beach resorts, hotels and restaurants that have to deal with sand leaving the beach.

Modern beach showers and foot cleaners currently available do not provide efficient cleaning because of where they are situated. When used, either one cleans one's feet completely and then steps in the inevitable puddle of sand and water that forms around the person, making their feet dirty again, or there may be too many people stopping to clean their feet so persons may avoid cleaning their feet altogether.

As a consequence, business owners spend thousands of dollars every year due to sandy and wet feet, be it due to cleaning sand out of pools, replacing paint since the sand and salt make it easier to chip or simply paying to clean the sand out of entire buildings.

Finally, present cleaning devices are not eco-friendly, consuming an alarming amount of water. An average running faucet uses around 2.2 gallons of water per minute. Spreading this amount over the time it takes for people to clean their feet using a one-dimensional stream adds up to an astonishing amount of wasted water.

The prior art has attempted to address this issue. For example, Korean Patent No. KR200461461Y1 only teaches maintaining the cleanliness inside the shower by only rinsing sand from the soles of the feet of the user inside shower.” Additionally, patent KR200461461Y1 only has water being sent to the bottom of the feet, and there is no drying feature.

### BRIEF SUMMARY OF THE INVENTION

The present invention provides a two-stage cleaning and drying device or appliance for, inter alia, removing sand from the feet of a person or an animal.

The device further includes a ramp for entry into the device. The device has a pair of sidewalls and a bottom wall. The mist sprayers are disposed in the first stage on both side walls, as well as in the bottom wall.

Similarly, the dryers are disposed in the side walls and in the bottom wall.

The first, or washing stage comprises a plurality of mist sprayers which sprays water from both the bottom and the sides.

The second stage is the drying stage that provides air drying for the feet. The first stage, or the washing stage, includes a sensor to detect entry of the feet of a user into the confines of the space. Motion detectors or similar detection devices sense the movement of the feet from the first stage to the second stage.

The dryer can be a conventional battery powered fan dryer, or it can use solar panels to actuate the dryers.

For a more complete understanding of the present invention, reference is made to the following detailed description and the accompanying drawing. In the drawing, like reference characters refer to like parts throughout the several views in which:

### DESCRIPTION OF THE DRAWINGS

FIG. 1 is a perspective view of the appliance hereof;

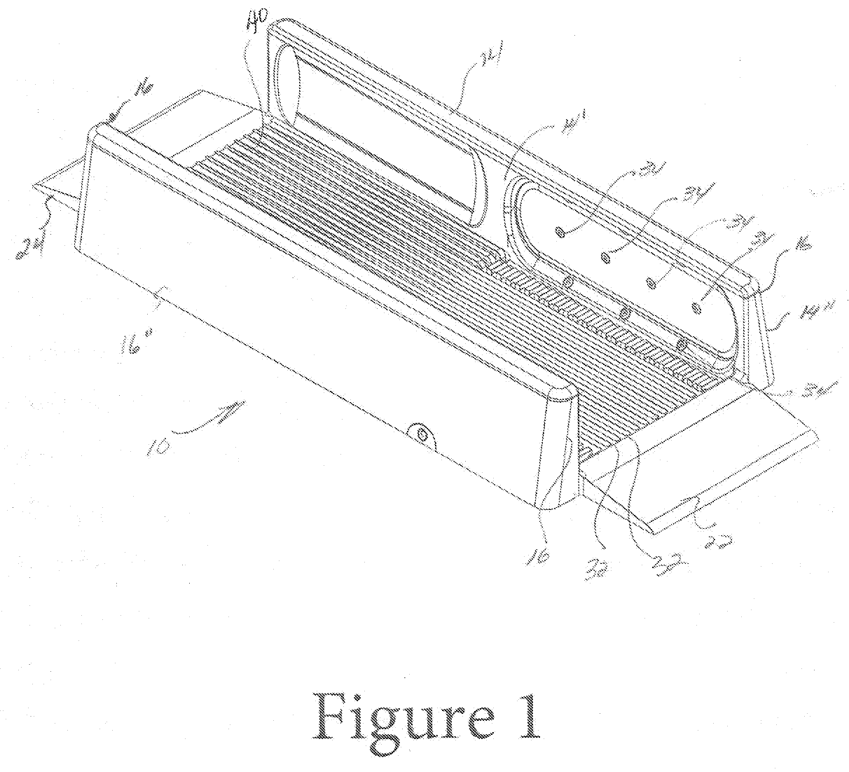

FIG. 2 is an exploded view of one side wall and the bottom of the appliance hereof;

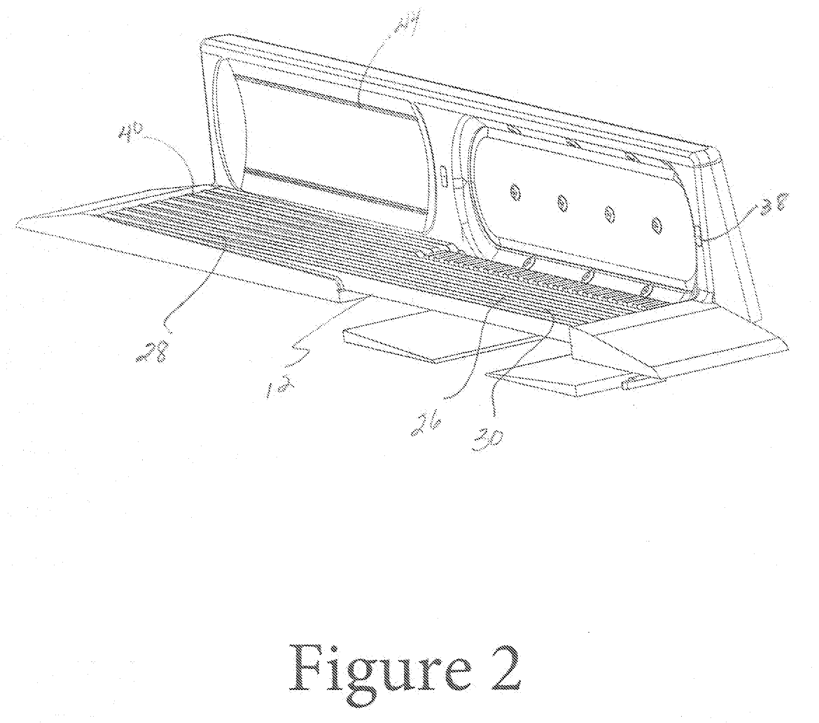

FIG. 3 is a top view, partly in perspective of the first stage of the present appliance;

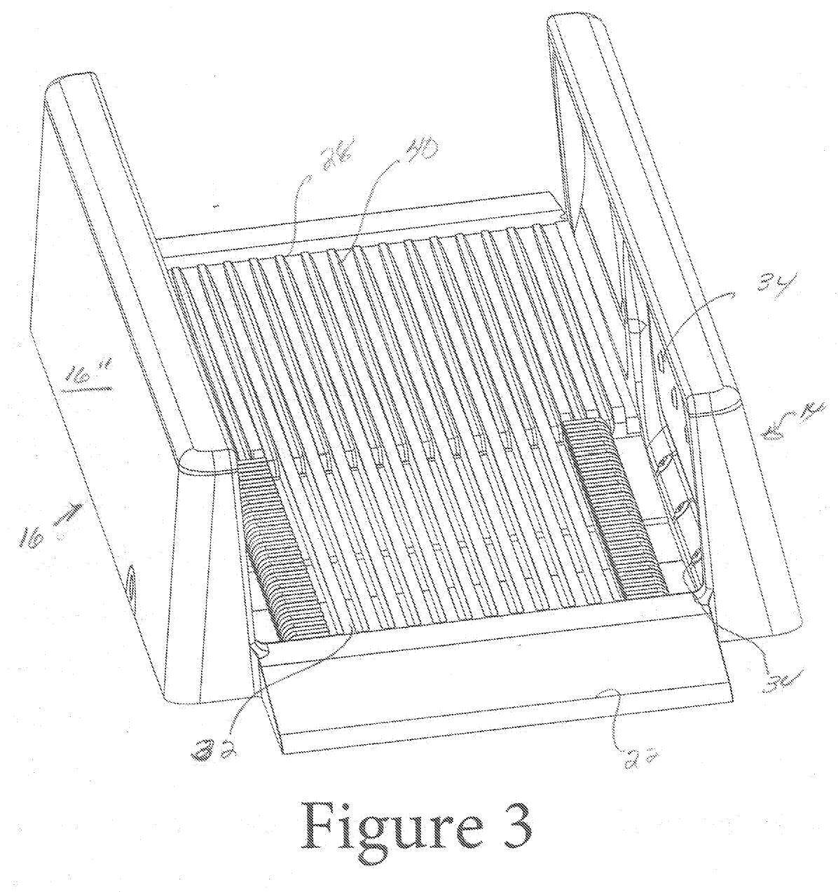

FIG. 4 is an exploded perspective of the present appliance as viewed, showing the detachability of the ramps;

FIG. 5 is a side view of the exterior of one side wall showing the water inlet and power inlet;

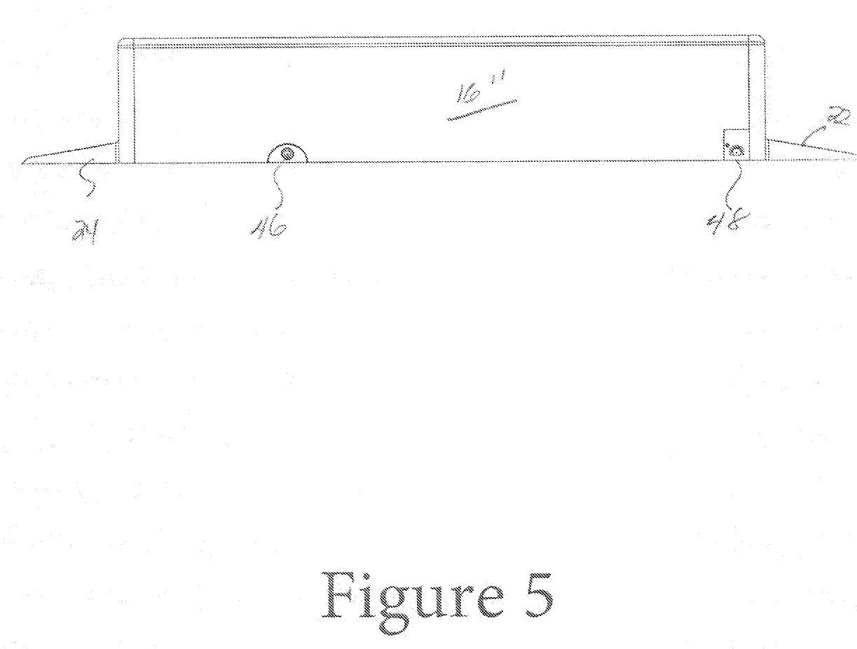

FIG. 6 is an exploded perspective view of the present invention depicting the manifold and blow dryer.

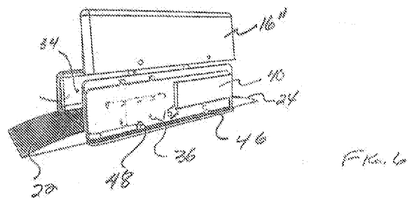

### DESCRIPTION OF THE INVENTION

Now, and with reference to the drawing, there is depicted therein a foot cleaning and drying apparatus or appliance, generally denoted at 10. The appliance 10 is an open interior device and includes a bottom wall 12 and a pair of upstanding spaced apart side walls 14 and 16 with an open space therebetween. The appliance includes a first section 18 denoted as the cleaning or washing section and a second or drying section 20.

An entry ramp 22 is disposed proximate the first section 18. A second or opposite ramp 24 defines an exit ramp.

With more particularity and with reference to side wall 14 which shows the interior of the side wall, it is to be understood that the opposite side wall 16 is similarly configured and constructed. Each sidewall 14, 16 has an interior surface 14′, 16′ and an exterior surface 14″, 16″, respectively, and a space or gap 15 therebetween.

The bottom wall 12 is divided into a first washing section 26 and a second drying section 28. The first section is coextensive with the first side walls. Similarly, the second section is substantially coextensive with the second side walls.

As shown, the first section of the bottom wall 26 comprises a grate 30, having a plurality of spaced apart slats 32. The slats 32 enable communication between the bottom wall and the environment to enable drainage of water and/or debris therefrom.

A plurality of sprinklers or misters 34 are disposed on the first section of each side wall. The sprinklers are deployed to issue water onto the feet of the user substantially therearound.

A manifold 36 is disposed in the space 15 in the first section of each side wall (only one of which is shown) and is in fluid communication with a source of water (not shown) via an inlet 48 to enable equal distribution of the water through the plurality of sprinklers or misters.

A motion sensor 38 is disposed proximate the entry into the first stage and is in electrical communication with the source of water to start the pumping of water through the sprinklers.

The starting of the misters is well known technology and does not form part of the present invention. It is rather the use of the motion sensor to actuate the pump to distribute the water through the manifold and therefrom to the misters is what is critical hereto.

The present invention contemplates that the misters will either stay on until the feet or foot of the user departs the first stage when they traverse into the second stage or for a predetermined amount of time at the election of the user or manufacturer of the appliance.

It should be known that the misters or sprinklers disposed proximate the bottom of the side wall are angled to enable water to drain through the grate to drain combined water and sand or other debris into the environment. This enable the first stage to be self-cleaning.

Referring again to the drawing, as shown, the second stage of the bottom wall has a plurality of slats 40 which are spaced apart and of sufficient strength to enable a user to stand thereon. Preferably, they are contiguous with or interdigitate with the slats of the first stage. However, as shown, these slats are elevated and extend upwardly from the bottom wall whereas the slats in the first stage are coextensive and coplanar with the bottom. By having the elevation associated with these slats, air can circulate underneath the feet of the user, as well as on the top of the feet.

A blow dryer 42 is installed in the second stage of each side wall. The dryer preferably comprises a blower operatively connected to a source of power (not shown), such as a battery or outlet or a solar panel which generates electricity. A power inlet 46 is in electrical communication with the dryer 42.

At least one vent 44 provided on the exterior of each side wall delivers drying air to the feet of a user.

As with the first stage, a motion sensor detects the presence of a user at the second stage.

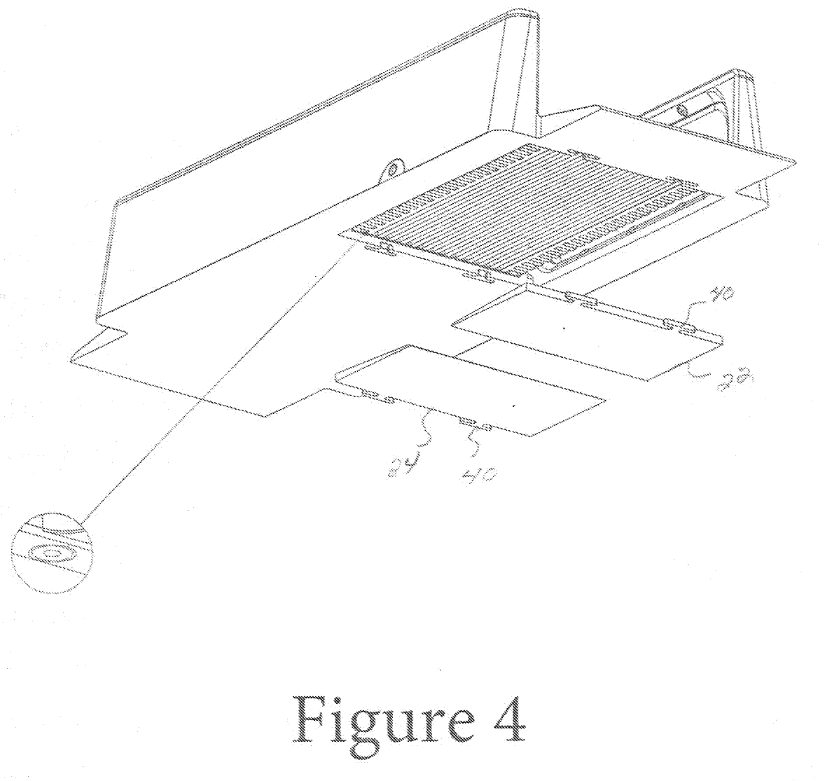

As shown in FIG. 4, each of the ramps 22, 24 are detachably mounted to the appliance at the bottom wall. Any suitable means of attachment such as hooks 46 or the like to render each of the ramps detachably removable therefrom.

From the above, it is to be readily perceived that there has been described herein an appliance for effectively cleaning and drying feet and which is particularly adapted for removing sand. However, it is to be understood that other debris, such as mud, can be easily washed from the feet and dried thereafter.

The present appliance is to be placed over an existing drain, hole or a new drain, such that the water combined with the debris or sand will readily drain into the existing drainage.

Having, thus, described the invention, what is claimed is:

### REFERENCE NUMBERS

10 Appliance
12 Bottom Wall
14 Sidewall
14′ Sidewall Interior Surface
14″ Sidewall Exterior Surface
16 Sidewall
16′ Sidewall Interior Surface
16″ Sidewall Exterior Surface
18 First Section
20 Second Section
22 Entry Ramp
24 Exit Ramp
26 First Washing Section
28 Second Drying Section
30 Grate
32 Slats
34 Misters
36 Manifold
38 Motion Sensor
40 Slats
42 Blow Dryer

1. A cleaning and drying appliance comprising:
a) a slatted bottom wall having a first stage and a second stage;
b) a pair of opposed upstanding side walls having an interior side and an exterior side with a space therebetween, each side wall having a first stage coextensive with the first stage of the bottom wall and a second stage coextensive with the second stage of the bottom wall.
c) a plurality of sprinklers disposed on the interior side of the first stage of the side walls and directed to the interior of the appliance;
d) a dryer disposed in at least one of the side walls and directing drying air inwardly toward the middle of the appliance.

2. The appliance of claim 1 which further comprises:
a) an entry ramp and an exit ramp, the entry ramp being disposed exteriorly of the appliance and connected to the appliance at the entry into the first stage, the exit ramp being disposed exteriorly of the appliance and removably secured to the appliance at the exit of the second stage.

3. The appliance of claim 1 which further comprises:
a) a first motion detector to detect entry of a foot of a user into the first stage and means for actuating the sprinklers in response to detection by the motion sensor.

4. The appliance of claim 1 which further includes a manifold for evenly distributing water operatively connected to each of the sprinklers for distributing an equal amount of water from each sprinkler.

5. The appliance of claim 1 which further comprises at least one dryer issuing air into the interior of the appliance for drying the feet of the user.

6. The appliance of claim 1 which further includes a second motion sensor to detect entry of the feet of the user into the second stage for actuating the dryer and means for actuating the dryer in response to a signal from the motion sensor.
